(19) United States
(12) Patent Application Publication
(10) Pub. No.: US 2026/0369880 A1
(43) Pub. Date: Nov. 19, 2026

(54) Direction-Deviating Backscatter Radio

(71) Applicant: TELEFONAKTIEBOLAGET LM ERICSSON (PUBL), Stockholm (SE)

(72) Inventors: Shousheng He, Södra Sandby (SE); Miguel Lopez, Stockholm (SE)

(21) Appl. No.: 19/476,048

(22) PCT Filed: Apr. 18, 2023
(86) PCT No.: PCT/EP2023/060024

§ 371 Date: Oct. 16, 2025

(51) Int. Cl. H01Q 3/24; H01Q 15/02

(52) U.S. Cl. CPC H01Q 3/24; H01Q 15/02

(57) ABSTRACT

A method and backscatter radio are disclosed. According to one aspect, a backscatter radio includes a Rotman lens having a plurality of array ports and a plurality of beam ports, each beam port being associated with a configurable impedance mismatch. The backscatter radio also includes a beam selection network configured to configure an impedance mismatch at least at a first beam port of the plurality of beam ports to steer a reflection of a beam from array ports of the plurality of array ports from a first direction to a second direction.

### TECHNICAL FIELD

The present disclosure relates to wireless communications, and in particular, to a direction-deviating backscatter radio.

### BACKGROUND

The Third Generation Partnership Project (3GPP) has developed and is developing standards for Fourth Generation (4G) (also referred to as Long Term Evolution (LTE)) and Fifth Generation (5G) (also referred to as New Radio (NR)) wireless communication systems. Such systems provide, among other features, broadband communication between network nodes, such as base stations, and mobile wireless devices (WD), as well as communication between network nodes and between WDs. The 3GPP is also discussing development of standards for Sixth Generation (6G) wireless communication networks.

In addition to these standards, the Institute of Electrical and Electronic Engineers (IEEE) has developed and continues to develop standards for other types of wireless communication networks, including Wireless Local Area Networks (WLANs), including Wireless Fidelity (Wi-Fi) networks and Bluetooth networks. WLANS include wireless communication between access points (APs) and WDs (non-AP STAs. Such IEEE standards include IEEE 802.11a/b/g/n/ac/ax and IEEE 802.15.

Back Scatter Radio (BSR) is a known communication signaling form widely used in radio frequency identification (RFID) and sensing devices, where the common constraint is an extremely low power supply. A BSR device (also known as a tag) does not have an active radio, but sends information by switching its antenna loading, to reflect, or backscatter an illuminating radio signal transmitted from a transmitter to a receiver. BSR systems may be configured in two forms, either monostatic, where the transmitter (of the illumination signal) and receiver are collocated, as shown in FIG. 1(a). or bistatic, where the transmitter and the receiver are separated in space, as shown in FIG. 1(b). Usually, a near field operation adopts a monostatic configuration while a bistatic configuration is used when the receiver may spatially discriminate the transmitter signal with a directional antenna array. With some specially designed array antennas, a retro-directing backscatter may also be constructed, which is used to strengthen the backscattering signal. For bistatic backscattering, retro-directing backscatter does not help, and no known energy efficient beam deviation method is available.

In the coming generation of wireless networks, BSR had been identified as one of the potential radio forms for implementing an Internet-of-things (IoT) network with zero-energy devices, where a zero-energy backscatter device utilizes radio frequency (RF) energy harvesting, or other form of energy harvesting for backscatter radio operation.

Some problems with the current form of BSR include:
The backscattered/reflected signal is very weak, partially due to the backscatter antenna not having much directional selectivity;
Even using directional antennas, the backscatter device does not have sufficient capability for beam steering to a desired direction, e.g., to separate the illumination and backscatter signals in space; and/or
A very strong interference from the illuminating signal, as self-interference (monostatic) or direct-path interference (bistatic), which may be as high as 80 dB over the backscattered signal, poses a severe challenge to the BSR receiver design. Since the frequency of the backscatter signal is very close to that of the illuminating signal, (due to the switching frequency of the backscatter device being very low and usually limited by constraints on power consumption), this interference cannot easily be filtered out in the frequency domain. The retro-directive BSR in a monostatic configuration does not remedy this problem by a significant amount.

### SUMMARY

Some embodiments advantageously provide methods and backscattering radios, for a direction-deviating backscatter radio.

A simple beam deviating method is introduce to a backscatter radio (BSR) that may be used to separate the backscatter signal from the illuminating signal in the spatial domain. The direction-deviating backscatter signal significantly enhances its strength with a beam selective BSR receiver.

Without changing the configuration of the backscatter radio, an “angle-mirrored” signal is backscattered in the proposed structure. The beam angle of the backscatter signal is controlled by a simple switching network together with a Rotman Lens, where a unique impedance mismatching scheme is utilized to steer the backscatter signal into a desired direction, either “angle-mirrored” direction-deviating or retro-directing.

A passive Rotman lens antenna array together with a simple switching network is introduced to the backscatter radio.

Instead of using all matched impedances, as in a conventional application of the Rotman lens, a selective single impedance mismatch is introduced to the beam ports of the Rotman lens, so that a reflection/backscattering beam of a desired direction is created.

For direction-deviating backscattering, the sole impedance mismatch is pre-selected in a way that the reflection resembles a signal transmission from the desired beam port corresponding to the angle-mirrored direction of the illuminating signal.

Advantages of the beam steering method for a BSR may include one or more of the following:
Beam steering significantly enhances the backscatter direction selectivity, which strengthens the backscatter signal by concentrating to a narrow beam;
Directs the backscatter signal to a desired direction of choice;
Can be used to spatially separate the illuminating and the backscatter signals, thereby significantly improving the performance of BSR radio receiver in both monostatic and bistatic configuration; and/or
Beam steering also reduces interference to other devices in the field.

A beam steering method is introduced with a passive Rotman lens and a simple associated switching network, so the steering method does not significantly increase the power consumption for the backscatter radio.

In addition to beam steering for BSR, some embodiments have potential for many other applications. (For example, Reconfigurable Intelligent Surfaces (RIS)).

Backscattering communications is relevant for mm wave, but in practice it is used only at low frequencies rarely exceeding 2.5 GHz. The reason is that at high frequencies, antenna arrays are designed to have sufficient coverage, but beam steering is challenging with low complexity backscattering radios. Rotman lenses, used as disclosed herein, may have small form factors for operation at mm waves and may be practical for low cost/low complexity backscattering radios.

The direction of the backscattering beam, either retro-directing or angle-mirrored direction-deviating, may be predetermined upon deployment.

According to one aspect, a method for steering a beam of a backscatter radio is provided. The method includes configuring a Rotman lens with a plurality of array ports and a plurality of beam ports, each beam port being associated with a configurable impedance mismatch. The method also includes configuring an impedance mismatch at least at a first beam port of the plurality of beam ports to steer a reflection of an impinging wave from array ports of the plurality of array ports to a selected direction.

According to this aspect, in some embodiments, both a direction of the impinging wave and the selected direction are a same monostatic backscatter direction. In some embodiments, a direction of the impinging wave is a direction of a transmitter of an illuminating signal and the selected direction is a direction of a receiver located separately from the transmitter in a bistatic backscatter configuration. In some embodiments, the selected direction deviates by a selectable angle from a monostatic backscatter angle. In some embodiments, the selected direction mirrors a direction of the impinging wave with respect to a central beam port of the Rotman lens. In some embodiments, the method includes configuring an impedance match at each remaining beam port of the plurality of beam ports. In some embodiments, configuring an impedance mismatch further includes configuring an impedance mismatch at a center beam port of the plurality of beam ports while an impedance at each remaining beam port of the plurality of beam ports are matched. In some embodiments, configuring an impedance mismatch includes configuring an impedance mismatch at least at the first beam port of the plurality of beam ports to cause waves to add constructively at least at one of the first beam port and a second beam port of the plurality of beam ports. In some embodiments, configuring an impedance mismatch includes configuring an impedance mismatch at least at the first beam port of the plurality of beam ports to cause waves to interfere destructively at least at one of the first beam port and a second beam port of the plurality of beam ports. In some embodiments, configuring an impedance mismatch includes configuring an impedance mismatch at each of multiple selected beam ports of the plurality of beam ports to shape side lobes of the steered reflection of the beam.

According to another aspect, a backscatter radio is provided. The backscatter radio includes a Rotman lens and a beam selection network. The Rotman lens includes a plurality of array ports and a plurality of beam ports, each beam port being associated with a configurable impedance mismatch. The beam selection network is configured to configure an impedance mismatch at least at a first beam port of the plurality of beam ports to steer a reflection of an impinging wave from array ports of the plurality of array ports to a selected direction.

According to this aspect, in some embodiments, both a direction of the impinging wave and the selected direction are a same monostatic backscatter direction. In some embodiments, a direction of the impinging wave is a direction of a transmitter of an illuminating signal and the selected direction is a direction of a receiver located separately from the transmitter in a bistatic backscatter configuration. In some embodiments, the selected direction deviates by a selectable angle from a direction of the impinging wave in a bistatic backscatter configuration. In some embodiments, the selected direction mirrors a direction of the impinging wave with respect to a central beam port of the Rotman lens. In some embodiments, the beam selection network is configured to configure an impedance match at each remaining beam port of the plurality of beam ports. In some embodiments, the beam selection network is configured to configure an impedance mismatch at a center beam port of the plurality of beam ports while an impedance at each remaining beam port of the plurality of beam ports are matched. In some embodiments, the beam selection network is configured to configure an impedance mismatch at least at the first beam port of the plurality of beam ports to cause waves to add constructively at least at one of the first beam port and a second beam port of the plurality of beam ports. In some embodiments, the beam selection network is configured to configure an impedance mismatch at least at the first beam port of the plurality of beam ports to cause waves to interfere destructively at least at one of the first beam port and a second beam port of the plurality of beam ports. In some embodiments, the beam selection network is configured to configure an impedance mismatch at each of multiple selected beam ports of the plurality of beam ports to shape side lobes of the reflection of the steered beam.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 illustrates monostatic backscattering and bistatic backscattering;

FIG. 2 is a schematic diagram of an example network architecture illustrating a communication system according to principles disclosed herein;

FIG. 3 is a block diagram of a network node in communication with a wireless device over a wireless connection according to some embodiments of the present disclosure;

FIG. 4 is a flowchart of an example process in a network node for XXX according to some embodiments of the present disclosure; and

FIG. 5 illustrates a simplified structure of a Rotman lens having array ports, beam ports and matched impedances at every beam port;

FIG. 6 illustrates a Rotman lens configured with a BSR beam selection network;

FIG. 7 illustrates a central beam port of a backscatter radio being controlled by an on-off signal;

FIG. 8 illustrates an off-center beam port of a backscatter radio being controlled by an on-off signal; and

FIG. 9 illustrates a simplified Rotman lens with 2 array ports and 3 beam ports.

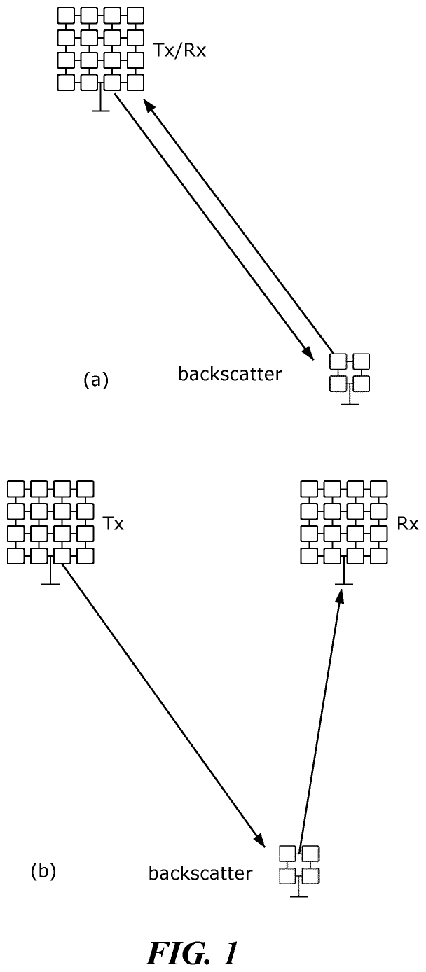

### DETAILED DESCRIPTION

Before describing in detail example embodiments, it is noted that the embodiments reside primarily in combinations of apparatus components and processing steps related to a direction-deviating backscatter radio. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The terminology used herein is for the purpose of describing particular embodiments only and is not intended to be limiting of the concepts described herein. As used herein, the singular forms “a,” “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

The term “network node” used herein may be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein may be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, a Narrowband IoT (NB-IoT) device, or an ambient IoT device etc.

Also, in some embodiments the generic term “radio network node” is used. It may be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, may be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Some embodiments are directed to a direction-deviating backscatter radio.

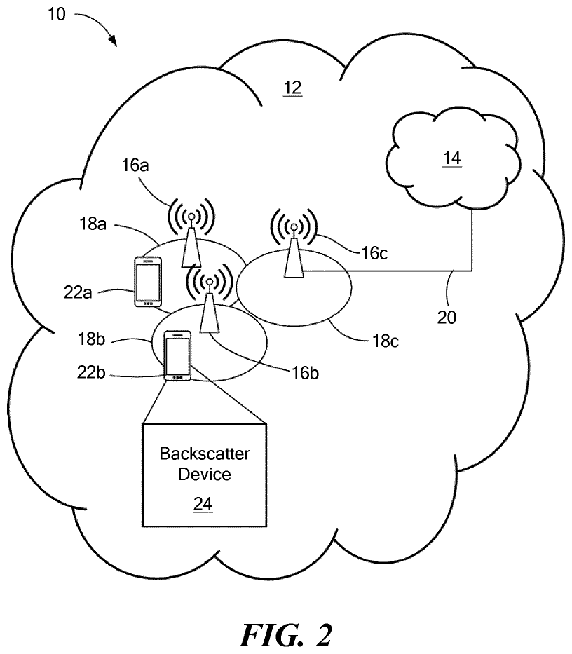

Returning to the drawing figures, in which like elements are referred to by like reference numerals, there is shown in FIG. 2 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 may be in simultaneous communication and/or configured to separately communicate with more than one network node 16 and more than one type of network node 16. For example, a WD 22 may have dual connectivity with a network node 16 that supports LTE and the same or a different network node 16 that supports NR. As an example, WD 22 may be in communication with an eNB for LTE/E-UTRAN and a gNB for NR/NG-RAN.

Example implementations, in accordance with an embodiment, of the WD 22 and network node 16 discussed in the preceding paragraphs will now be described with reference to FIG. 2.

The communication system 10 includes a network node 16 provided in a communication system 10 and including hardware 28 enabling it to communicate with the WD 22. The hardware 28 may include a radio interface 30 for setting up and maintaining at least a wireless connection 32 with a WD 22 located in a coverage area 18 served by the network node 16. The radio interface 30 may be formed as or may include, for example, one or more RF transmitters, one or more RF receivers, and/or one or more RF transceivers. The radio interface 30 includes an array of antennas 34 to radiate and receive signal(s) carrying electromagnetic waves.

In the embodiment shown, the hardware 28 of the network node 16 further includes processing circuitry 36. The processing circuitry 36 may include a processor 38 and a memory 40. In particular, in addition to or instead of a processor, such as a central processing unit, and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 42 stored internally in, for example, memory 40, or stored in external memory (e.g., database, storage array, network storage device, etc.) accessible by the network node 16 via an external connection. The software 42 may be executable by the processing circuitry 36. The processing circuitry 36 may be configured to control any of the methods and/or processes described herein and/or to cause such methods, and/or processes to be performed, e.g., by network node 16. Processor 38 corresponds to one or more processors 38 for performing network node 16 functions described herein. The memory 40 is configured to store data, programmatic software code and/or other information described herein. In some embodiments, the software 42 may include instructions that, when executed by the processor 38 and/or processing circuitry 36, causes the processor 38 and/or processing circuitry 36 to perform the processes described herein with respect to network node 16.

The communication system 10 further includes the WD 22 already referred to. The WD 22 may have hardware 44 that may include a radio interface 46 configured to set up and maintain a wireless connection 32 with a network node 16 serving a coverage area 18 in which the WD 22 is currently located. The radio interface 46 may be formed as or may include, for example, one or more RF transmitters, one or more RF receivers, and/or one or more RF transceivers. The radio interface 46 includes an array of antennas 48 to radiate and receive signal(s) carrying electromagnetic waves.

The hardware 44 of the WD 22 further includes processing circuitry 50. The processing circuitry 50 may include a processor 52 and memory 54. In particular, in addition to or instead of a processor, such as a central processing unit, and memory, the processing circuitry 50 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 52 may be configured to access (e.g., write to and/or read from) memory 54, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 56, which is stored in, for example, memory 54 at the WD 22, or stored in external memory (e.g., database, storage array, network storage device, etc.) accessible by the WD 22. The software 56 may be executable by the processing circuitry 50. The software 56 may include a client application 58. The client application 58 may be operable to provide a service to a human or non-human user via the WD 22.

The processing circuitry 50 may be configured to control any of the methods and/or processes described herein and/or to cause such methods, and/or processes to be performed, e.g., by WD 22. The processor 52 corresponds to one or more processors 52 for performing WD 22 functions described herein. The WD 22 includes memory 54 that is configured to store data, programmatic software code and/or other information described herein. In some embodiments, the software 56 and/or the client application 58 may include instructions that, when executed by the processor 52 and/or processing circuitry 50, causes the processor 52 and/or processing circuitry 50 to perform the processes described herein with respect to WD 22.

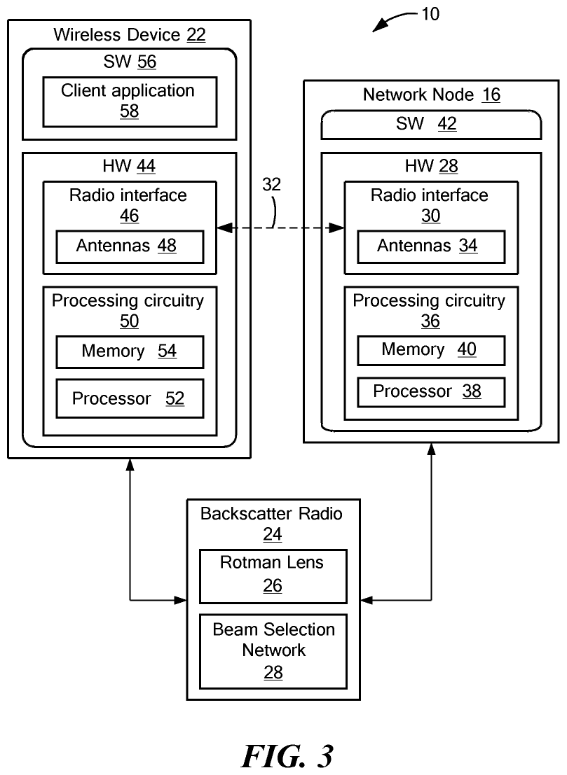

In some embodiments, the inner workings of the network node 16 and WD 22 may be as shown in FIG. 3 and independently, the surrounding network topology may be that of FIG. 2.

The wireless connection 32 between the WD 22 and the network node 16 is in accordance with the teachings of the embodiments described throughout this disclosure. More precisely, the teachings of some of these embodiments may improve the data rate, latency, and/or power consumption and thereby provide benefits such as reduced user waiting time, relaxed restriction on file size, better responsiveness, extended battery lifetime, etc. In some embodiments, a measurement procedure may be provided for the purpose of monitoring data rate, latency and other factors on which the one or more embodiments improve.

FIG. 3 also shows a backscatter radio 24 which includes a Rotman lens 26 having a plurality of array ports and a plurality of beam ports, each beam port being associated with a configurable impedance mismatch. A Rotman lens is a special type of array antenna system, and a passive Rotman lens is used for direction-deviating backscatter, in some embodiments. The backscatter radio 24 also includes a beam selection network 28 configured to configure an impedance mismatch at least at a first beam port of the plurality of beam ports to steer a reflection of a beam from array ports of the plurality of array ports from a first direction to a second direction. The beam selection network 28 may include processing circuitry such as a microprocessor and associated memory and/or configurable switching circuitry to configure one or more impedance mismatches at the beam ports of the Rotman lens 26.

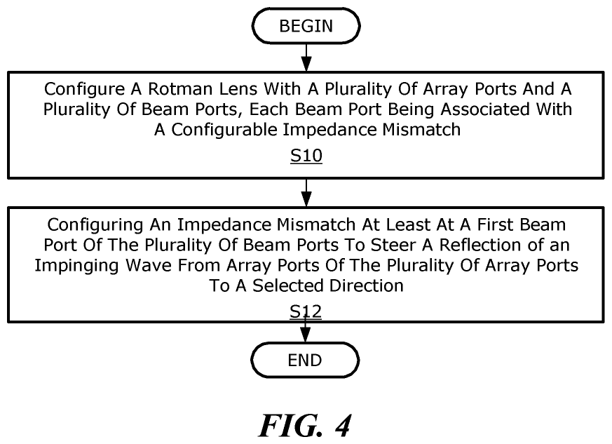

FIG. 4 is a flowchart of an example process for steering a beam of a backscatter radio 24 for a direction-deviating backscatter radio. The process includes configuring a Rotman lens 26 with a plurality of array ports 62 and a plurality of beam ports 60, each beam port 60 being associated with a configurable impedance mismatch (Block S10). The process also includes configuring an impedance mismatch at least at a first beam port 60 of the plurality of beam ports 60 to steer a reflection of an impinging wave from array ports 62 of the plurality of array ports 62 to a selected direction (Block S12).

In some embodiments, both a direction of the impinging wave and the selected direction are a same monostatic backscatter direction. In some embodiments, a direction of the impinging wave is a direction of a transmitter of an illuminating signal and the selected direction is a direction of a receiver located separately from the transmitter in a bistatic backscatter configuration. In some embodiments, the selected direction deviates by a selectable angle from a monostatic backscatter angle. In some embodiments, the selected direction mirrors a direction of the impinging wave with respect to a central beam port 60 of the Rotman lens 26. In some embodiments, the method includes configuring an impedance match at each remaining beam port 60 of the plurality of beam ports 60. In some embodiments, configuring an impedance mismatch further includes configuring an impedance mismatch at a center beam port 60 of the plurality of beam ports 60 while an impedance 64 at each remaining beam port 60 of the plurality of beam ports 60 are matched. In some embodiments, configuring an impedance mismatch includes configuring an impedance mismatch at least at the first beam port 60 of the plurality of beam ports 60 to cause waves to add constructively at least at one of the first beam port 60 and a second beam port 60 of the plurality of beam ports 60. In some embodiments, configuring an impedance mismatch includes configuring an impedance mismatch at least at the first beam port 60 of the plurality of beam ports 60 to cause waves to interfere destructively at least at one of the first beam port 60 and a second beam port 60 of the plurality of beam ports 60. In some embodiments, configuring an impedance mismatch includes configuring an impedance mismatch at each of multiple selected beam ports 60 of the plurality of beam ports 60 to shape side lobes of the steered reflection of the beam.

Having described the general process flow of arrangements of the disclosure and having provided examples of hardware and software arrangements for implementing the processes and functions of the disclosure, the sections below provide details and examples of arrangements for a direction-deviating backscatter radio.

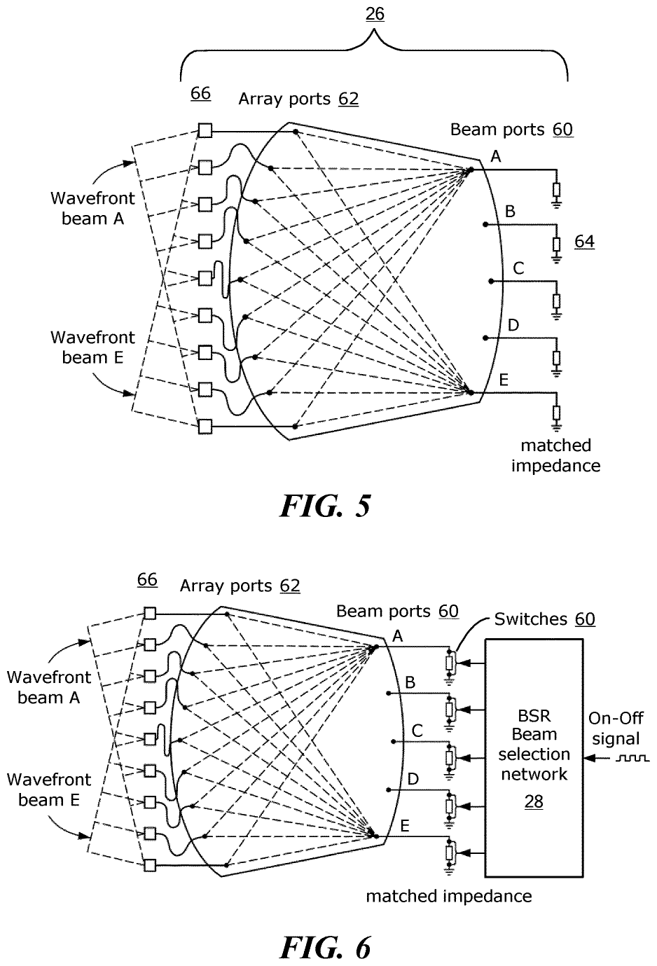

The proposed steering method utilizes a Rotman lens 26, also referred to herein as a Rotman lens antenna 26. A Rotman lens antenna 26 has been conventionally used for beam scanning for either transmitter or receiver. FIG. 5 shows a simplified Rotman lens antenna 26 having beam ports 60, array ports 62, impedance 64 and an array of antennas 66. Due to a design of the signal path based on the True Time Delay (TTD) propagation, the antenna signals from a specific beam direction will add constructively at the corresponding beam port, and will destructively sum to nearly zero at all the other beam ports 60. Note, perfect constructive and destructive interference is only possible under the assumption that the beam ports 60 are all impedance-matched via impedances 64.

As shown in FIG. 6, a Rotman lens 26 is combined with a beam selection network 28 which routes an On-Off signal to the desired beam port 60 that controls a bypass switch of the matched impedance 64. When the bypass switch which is closed, the corresponding impedance 64 is short-circuited to ground and completely impedance mismatched, thereby steering the backscatter signal.

Although the beam selection network 28 is simple, the operation of the beam steering is based on a solid wave guide principle.

In the following description, assume the matched impedance 64 is controlled by a short-circuiting switch. When the control signal is ‘On’ (voltage level high), the switch 68 is closed, and a mismatch of the impedance 64 (close to zero) for the corresponding beam port 60 occurs. Ideally, an open circuit may have a similar effect. However, it has been shown that open-circuit termination of beam ports 60 for Rotman lens 26 may not work well.

### Deviating Backscatter

In a bistatic configuration, it is desirable that the beam of backscatter signal deviates from the illuminating signal, so that a spatial separation may be achieved. For example, if the BSR device is expected to backscatter an illumination signal from a beam direction corresponding to beam port A to the beam direction corresponding to beam port E, the On-Off signal is simply routed to the control switch 68 at that of the central beam port C, while the beam ports 60 A,B,D,E are matched, as shown in FIG. 6.

The proposed beam steering is founded at least in part on the general wave guide propagation principle. Once any of the beam ports 60, e.g., the central beam port, in a Rotman lens 26 is totally impedance mismatched, e.g., short circuited to ground, the signals at every array port 62 is totally reflected and no signal energy is propagated to any matched beam port, and thus neither destructive nor constructive summation occurs. Strong reflection or backscatter will thereby be created from the mismatched beam port 60 and propagates through the array ports 62, where the phases of the backscattered signals are to be aligned for the corresponding angle-mirror beam direction according to their individual phase shift. Reflecting in the angle-mirror beam direction means the backscatter signal has the opposite angle as the impinging signal relative to the central beam. For example, in FIG. 6, when the illumination signal comes with the beam direction correcting to beam port A, the backscattered signal will form a beam corresponding to beam port E.

In practice, a Rotman lens 26 with an odd ((2L−1), L being an integer) number of beam ports 60 may be constructed to facilitate backscattering in a particular direction. Then, the illumination signal arriving from a beam direction corresponding to the beam port (L−k), k<L will be backscattered in the angle-mirrored direction corresponding to beam port (L+k), and vice versa.

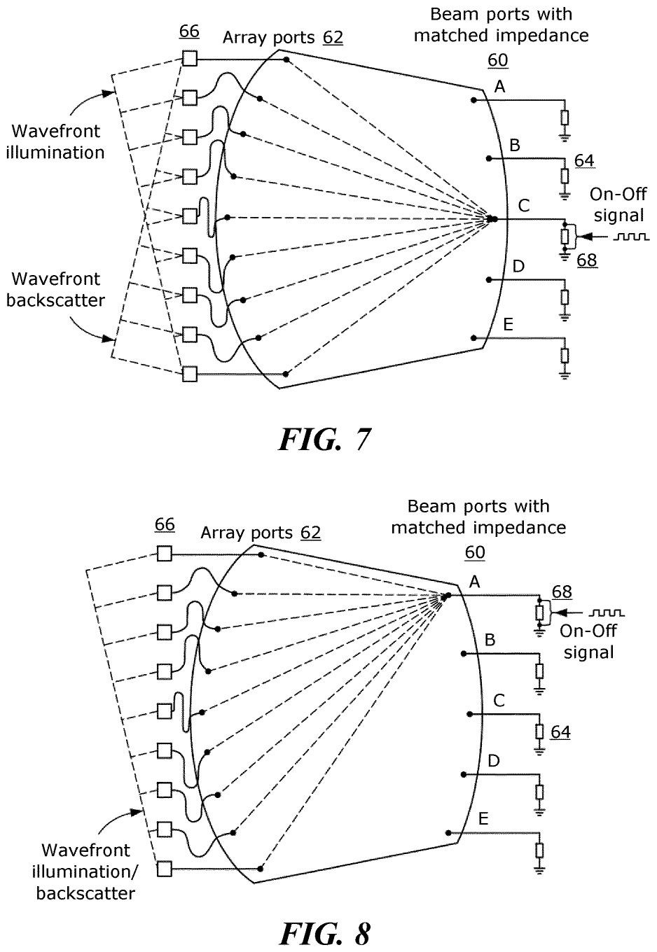

The reflection or backscattering may be also seen by looking at each individual signal from the array ports 62. Due to the enforced impedance mismatch, all the signals from different array ports 62 are phase-reversed at the mismatched beam port 60 and reflected back to the array ports 62 with corresponding delays, together with latencies caused by the Angle of Arrival (AoA) of the impinging signal, to form a wave front for the desired angle-mirror direction of the backscatter signal. In another words, through the true time delay (TTD) propagation form the center beam port 60 to the antenna array, a wavefront corresponding to the desired angle-mirrored beam is created. See FIG. 7.

### Retro-Directing Backscatter

Not only may a beam be backscattered along a desired direction that deviates from a direction of the incoming beam, a retrodirective backscattering may be also implemented, which will be desirable in a monostatic BSR configuration, as shown in FIG. 8.

### An S-Parameters Based Analysis and Concept Proof

### a Simplified S-Parameter Model

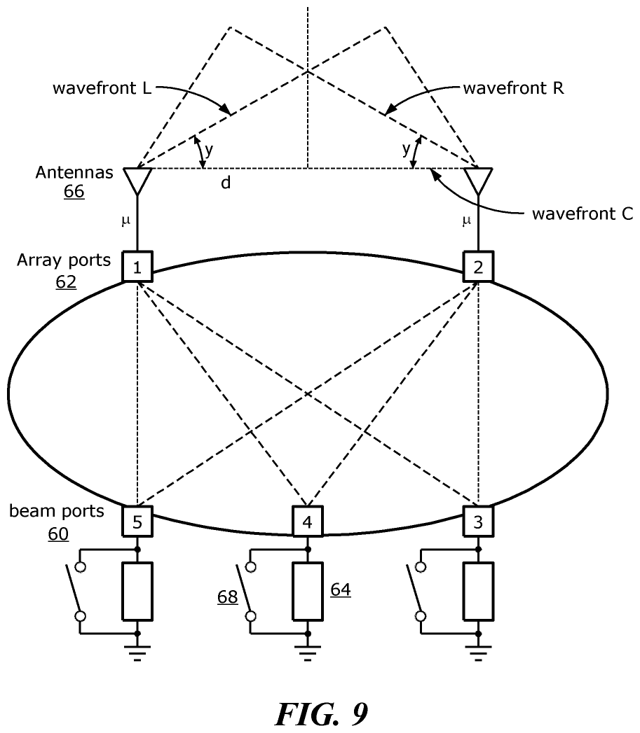

To simplify the proof, consider a simplified Rotman lens 26 with only 2 array ports 62 and 3 beam ports 60, as shown in FIG. 9, where the ports are labeled 1 to 5. The lens is designed for beamforming at the resolution of 3. Beam ports 3, 4 and 5 may respond to RF signal beams, via array port 1 and 2, from left, central and right respectively.

Assume the constructed Rotman lens 26 possesses the following properties, which are consistent with the design practice of Rotman lenses 26 in general:
1. The device is a passive and reciprocal network, having a TTD property from any array port 62 to any beam port 60 when the impedances 64 of all the beam ports 60 are matched;
2. The device is a lossless passive network;
3. In a classical application of the Rotman Lens, the impedances 64 of all the ports are perfectly matched to the respective source and load impedances. For example, when used as receiving antenna, the load impedances at the beam ports 60 may be matched to the reference impedance of R₀=50Ω;
4. There is no coupling between array ports 62; and/or
5. There is no coupling among beam ports 60.

The Rotman lens 26 in FIG. 9 may be modeled as a 5-port network and charactered with the scattering parameters, or S-parameters:

b=Sa. (1)

Or in an explicit 5×5-matrix form,

$$[ \begin{matrix}{b}_{1} \\ {b}_{2} \\ {b}_{3} \\ {b}_{4} \\ {b}_{5}\end{matrix} ] = [ \begin{matrix}{S}_{11} & {S}_{12} & {S}_{13} & {S}_{14} & {S}_{15} \\ {S}_{21} & {S}_{22} & {S}_{23} & {S}_{24} & {S}_{25} \\ {S}_{31} & {S}_{32} & {S}_{33} & {S}_{34} & {S}_{35} \\ {S}_{41} & {S}_{42} & {S}_{43} & {S}_{44} & {S}_{45} \\ {S}_{51} & {S}_{52} & {S}_{53} & {S}_{54} & {S}_{55}\end{matrix} ] [ \begin{matrix}{a}_{1} \\ {a}_{2} \\ {a}_{3} \\ {a}_{4} \\ {a}_{5}\end{matrix} ] . \qquad ( 2 )$$

Property 1 implies a symmetrical S-matrix;

Sᵢⱼ=Sⱼᵢ,i=1, . . . 5;j=1, . . . ,5; (3)

Property 2 guarantee that S is a unitary matrix;

Property 3 leads to:

Sᵢⱼ=0,i=1, . . . ,5; (4)

Property 4 indicates:

Sᵢⱼ=0,i,j∈{1,2},i≠j; (5)

Property 5 indicates:

Sᵢⱼ=0,i,j∈{3,4,5},i≠j; (6)

Due to all the properties above, the S-matrix becomes fairly sparse with only a few independent parameters:

$$S = [ \begin{matrix} & & {S}_{13} & {S}_{14} & {S}_{15} \\ & & {S}_{23} & {S}_{24} & {S}_{25} \\ {S}_{13} & {S}_{23} & & & \\ {S}_{14} & {S}_{24} & & & \\ {S}_{15} & {S}_{25} & & & \end{matrix} ] , \qquad ( 7 )$$

### Rotman Lens in a Beamforming Operation

The remaining parameters in equation (7) may be determined with a classical beamforming application. Consider an RF signal of the designated frequency propagation from the left. Due to the left-slant of the wavefront, the wavefront will reach the array ports 62 with different latencies. The signal at port 1 will experience a phase delay e^{-jφ}^{₁}, where φ₁=μ₁ is the phase delay introduced by the delay line connecting antenna and array port 1. The signal at port 2 will have a phase delay e^{-jφ}^{₂}, where

$${φ}_{2} = ω τ + {μ}_{2} = ω \frac{d sin α}{C} + {μ}_{2} ,$$

ω is the angular frequency of the RF signal, d is antenna spacing, C is the speed of light, and μ₂ is introduced by the delay line connecting the antenna and array port 2. For this simple case, μ₁=μ₂=μ, which may be used to adjust the angle width. From port 1 and port 2 to ports 3, 4 and 5, due to the TTD nature of the Rotman lens 26, the RF signal experiences delays of α^{-jθ}^{₁₃}, e^{-jθ}^{₁₄}, e^{-jθ}^{₁₅}, e^{-jθ}^{₂₃}, e^{-jθ}^{₂₄}, e^{-jθ}^{₂₅}, respectively. Consider geometrical symmetry. Then, θ₁₃=θ₂₅; θ₁₄=θ₂₄; and θ₁₅=θ₂₃. Thus the S-matrix in eqn (7) has only 3 independent parameters and becomes

$$S = [ \begin{matrix} & & {e}^{- j {θ}_{13}} & {e}^{- j {θ}_{14}} & {e}^{- j {θ}_{15}} \\ & & {e}^{- j {θ}_{15}} & {e}^{- j {θ}_{14}} & {e}^{- j {θ}_{13}} \\ {e}^{- j {θ}_{13}} & {e}^{- j {θ}_{15}} & & & \\ {e}^{- j {θ}_{14}} & {e}^{- j {θ}_{14}} & & & \\ {e}^{- j {θ}_{15}} & {e}^{- j {θ}_{13}} & & & \end{matrix} ] , \qquad ( 8 )$$

For beamforming operation with perfectly matched impedances 64, the RF signal coming from the left will be constructively added at beam port 3, and destructively summed at beam ports 4 and 5. This imposes 3 constraints in the form of θ₁₃=θ₁₅+φ+2kπ

θ₁₄=θ₁₄+φ+ (2k−1)π (9)

θ₁₅=θ₁₃+φ+ (2k−1)π
where k is an integer. Eqn (9) is under-constrained, allowing multiple solutions. For example, one solution may obtained by letting k=0; θ₁₃=θ₁₅+φ;

$$φ = \frac{π}{2} ;$$

and θ₁₄=(θ₁₃+θ₁₅)/2. (10)

### Retro-Directing Backscatter

When a Rotman lens 26 is combined with the proposed switching network and used for backscatter operation, one of the beam ports 60 is periodically mismatched by shorting circuit to ground due to the by-passing switch. The backscatter functionality depends on the reflection coefficients at the array ports 62 under loaded beam ports 60, as analyzed herein. Without loss of generality, assume an RF signal arrives from the left. For retro-directed backscattering, the switching signal is applied to short the load of beam port 3. Then, consider the reflection coefficients at the array ports 62 when the beam port 3 is shorted to ground. The effect of shorting beam port 3 to ground is:

$${ρ}_{33} = \frac{{b}_{3}}{{a}_{3}} = - 1 , \qquad ( 11 )$$

where ρᵢⱼ denotes the reflection coefficient of port i, when port j is mismatched by shorting to ground.

Due to the mismatch, the reflection coefficients of both array ports 62, port 1 and port 2 are also changed. Substituting equation (10) into equation (2), after some manipulation, the reflection coefficient of array port 1 and port 2 are:

$${ρ}_{13} = {S}_{11} + \frac{{S}_{13} {S}_{31}}{{ρ}_{33} - {S}_{33}} , \qquad ( 12 )$$

$${ρ}_{23} = {S}_{22} + \frac{{S}_{23} {S}_{32}}{{ρ}_{33} - {S}_{33}} , \qquad ( 13 )$$

respectively. Taking equation (8) and equation (11) into consideration

$${ρ}_{13} = - {S}_{13}^{2} = - {e}^{- 2 j {θ}_{13}} = {e}^{- j ( 2 {θ}_{13} + π )} , \qquad ( 14 )$$

$${ρ}_{23} = - {S}_{23}^{2} = - {e}^{- 2 j {θ}_{15}} = {e}^{- j ( 2 {θ}_{15} + π )} . \qquad ( 15 )$$

Note that ρ₃₃=−1 introduces a constant phase delay that reverses the phase of the signal. Since the left-travelling beam causes the impinging signal at port 2 to have an initial delay of φ, taking eqn(10) into consideration, the accumulated phase delay of the reflected signals at port 1 and 2 are:

σ₁=2θ₁₃+π=2(θ₁₅+φ)+π=2θ₁₅+2φ+π (16)

σ₂=2θ₁₅+φ+π (17)

That is, the reflected signal at port 1 has an extra delay of q, and the wave front of a left-travelling beam is formed when the reflected signal from port 2 experiences additional delay of q. This is shown in Error! Reference source not found . . .

### Deviating Backscatter

For deviating backscattering, let the central beam port 4 be shorted to ground:

$${ρ}_{44} = - 1 , \qquad ( 18 )$$

$${ρ}_{14} = {S}_{11} + \frac{{S}_{14} {S}_{41}}{{ρ}_{44} - {S}_{44}} , \qquad ( 19 )$$

$${ρ}_{24} = {S}_{22} + \frac{{S}_{24} {S}_{42}}{{ρ}_{44} - {S}_{44}} . \qquad ( 20 )$$

Taking equation (8) into consideration:

$${ρ}_{14} = - {S}_{14}^{2} = - {e}^{- 2 j {θ}_{14}} = {e}^{- j ( 2 {θ}_{14} + π )} , \qquad ( 21 )$$

$${ρ}_{24} = - {S}_{24}^{2} = - {e}^{- 2 j {θ}_{14}} = {e}^{- j ( 2 {θ}_{14} + π )} . \qquad ( 22 )$$

Thus, the reflected signal at array ports 62 1 and 2 experience the same phase shift. Since the impinging signal at port 2 already has a delay of φ, the reflected signal at port 1 must experience the same delay of φ, so the formed wave front is that of a “angle mirrored” wave front, i.e., a right-travelling wave front.

### Backscatter Summary

The significance of equations (11) through (22) may be summarized as follows:
1. Since all |ρᵢⱼ|_{i∈{1,2};j∈{3,4,5}}=1, the energy of the input signals of the array ports 62 from the antenna array is completely reflected and substantially no energy reaches any beam port 60 that has matched impedance 64. At the mismatched port, the energy from all the array ports 62 is phase-inverted, and completely reflected back.
2. Therefore, there is neither constructive summation nor destructive summation at any matched beam port.
3. A specific phase shift has been imposed on all the reflected signals. The shift is dependent on the true time delay (TTD) between the array port 62 and the mismatched beam port. This is independent of the direction of arrival of the RF signal. Looking from an array port 62, the phase shift of the reflection is as if the signal has traveled from this array port 62 to the mismatched port, phase-inverted and then traveled back.
4. Taking 3 into consideration, the phases of the refection signals appearing at the array ports 62 are as if a signal source is imposed at a specific beam port:
   a. For retro-directing backscattering, the beam port 60 of the illuminating beam;
   b. For direction-deviating backscattering, the beam port 60 of the angle-mirrored illuminating beam. That is, when the illumination beam is beam port (L−k), the reflection will correspond to beam port (L+k), and vice versa.

The proof may be easily extended to the general case that the beam selection network 28 is associated with an m×n, Rotman lens 26 where n is an odd integer. Therefore, embodiments are not limited to the number of beam ports 60 and array ports 62 shown in the drawing figures.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that may be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that may direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments may be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

| Abbreviation | Explanation |
|---|---|
| AoA: | Angle of Arrival |
| BSR: | Back Scatter Radio |
| RFID: | Radio Frequency Identification |
| TTD: | True Time Delay |

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1-20. (canceled)

21. A method for steering a beam of a backscatter radio, the method comprising:
configuring a Rotman lens with a plurality of array ports and a plurality of beam ports, each beam port being associated with a configurable impedance mismatch; and
configuring an impedance mismatch at least at a first beam port of the plurality of beam ports to steer a reflection of an impinging wave from array ports of the plurality of array ports to a selected direction.

22. The method of claim 21, wherein both a direction of the impinging wave and the selected direction are a same monostatic backscatter direction.

23. The method of claim 21, wherein a direction of the impinging wave is a direction of a transmitter of an illuminating signal and the selected direction is a direction of a receiver located separately from the transmitter in a bistatic backscatter configuration.

24. The method of claim 21, wherein the selected direction deviates by a selectable angle from a monostatic backscatter angle.

25. The method of claim 21, wherein the selected direction mirrors a direction of the impinging wave with respect to a central beam port of the Rotman lens.

26. The method of any claim 21, further comprising configuring an impedance match at each remaining beam port of the plurality of beam ports.

27. The method of claim 21, wherein configuring an impedance mismatch further includes configuring an impedance mismatch at a center beam port of the plurality of beam ports while an impedance at each remaining beam port of the plurality of beam ports are matched.

28. The method of claim 21, wherein configuring an impedance mismatch includes configuring an impedance mismatch at least at the first beam port of the plurality of beam ports to cause waves to add constructively at least at one of the first beam port and a second beam port of the plurality of beam ports.

29. The method of any of claim 21, wherein configuring an impedance mismatch includes configuring an impedance mismatch at least at the first beam port of the plurality of beam ports to cause waves to interfere destructively at least at one of the first beam port and a second beam port of the plurality of beam ports.

30. The method of any of claim 21, wherein configuring an impedance mismatch includes configuring an impedance mismatch at each of multiple selected beam ports of the plurality of beam ports to shape side lobes of the steered reflection of the beam.

31. A backscatter radio, the backscatter radio comprising:
a Rotman lens having a plurality of array ports and a plurality of beam ports, each beam port being associated with a configurable impedance mismatch; and
a beam selection network configured to configure an impedance mismatch at least at a first beam port of the plurality of beam ports to steer a reflection of an impinging wave from array ports of the plurality of array ports to a selected direction.

32. The backscatter radio of claim 31, wherein both a direction of the impinging wave and the selected direction are a same monostatic backscatter direction.

33. The backscatter radio of claim 31, wherein a direction of the impinging wave is a direction of a transmitter of an illuminating signal and the selected direction is a direction of a receiver located separately from the transmitter in a bistatic backscatter configuration.

34. The backscatter radio of claim 31, wherein the selected direction deviates by a selectable angle from a monostatic backscatter direction.

35. The backscatter radio of claim 31, wherein the selected direction mirrors a direction of the impinging wave with respect to a central beam port of the Rotman lens.

36. The backscatter radio of claim 31, wherein the beam selection network is configured to configure an impedance match at each remaining beam port of the plurality of beam ports.

37. The backscatter radio of claim 31, wherein the beam selection network is configured to configure an impedance mismatch at a center beam port of the plurality of beam ports while an impedance at each remaining beam port of the plurality of beam ports are matched.

38. The backscatter radio of claim 31, wherein the beam selection network is configured to configure an impedance mismatch at least at the first beam port of the plurality of beam ports to cause waves to add constructively at least at one of the first beam port and a second beam port of the plurality of beam ports.

39. The backscatter radio of claim 31, wherein the beam selection network is configured to configure an impedance mismatch at least at the first beam port of the plurality of beam ports to cause waves to interfere destructively at least at one of the first beam port and a second beam port of the plurality of beam ports.

40. The backscatter radio of claim 31, wherein the beam selection network is configured to configure an impedance mismatch at each of multiple selected beam ports of the plurality of beam ports to shape side lobes of the steered reflection of the beam.
